(19) United States
(12) Patent Application Publication
(10) Pub. No.: US 2015/0121888 A1
(43) Pub. Date: May 7, 2015

(54) GAS TURBINE ONLINE WASH CONTROL

(71) Applicant: General Electric Company, Schenectady, NY (US)

(72) Inventors: Sanji Ekanayake, Mableton, GA (US); Alston Ilford Scipio, Mableton, GA (US); Thomas Edward Wickert, Greenville, SC (US); Douglas Frank Beadie, Greer, SC (US); Scott Andrew Childers, Gray Court, SC (US)

(73) Assignee: General Electric Company, Schenectady, NY (US)

(21) Appl. No.: 14/072,227

(22) Filed: Nov. 5, 2013

(51) Int. Cl. F02C 7/30

(52) U.S. Cl. CPC F02C 7/30; F05D 2260/95; F05D 2270/30
USPC 60/772; 60/801

(57) ABSTRACT

A gas turbine online wash control system may obtain geospatial data for an area in which a gas turbine is located. The gas turbine online wash control system may determine wash control parameters for the gas turbine based on the geospatial data.

### BACKGROUND

Gas turbines, which may also be referred to as combustion turbines, are internal combustion engines that pressurize air and add heat to the air by combusting fuel in a chamber to increase the temperature of the gases that make up the air, expanding the gases. The gases are then directed towards a turbine to extract the energy generated by the hot, expanded gases. Gas turbines have many practical applications, including use as jet engines and in industrial power generation systems.

Gas turbines are exposed to a variety of atmospheric and environmental factors during normal operation. While most stationary gas turbines are equipped with an inlet air filtration system, it is not possible to prevent all atmospheric and environmental matter from entering the turbine. Thus, gas turbine components become fouled over time due to various atmospheric and environmental factors. To address this fouling, gas turbine components may be cleaned or “washed” offline (i.e., when not in operation) and online (i.e., while operating). While improving the operational lifespan of a gas turbine, washing can also contribute wear to gas turbine components. Therefore, a gas turbine operator will seek to improve wash efficacy by better controlling washing frequency, duration, and method to increase the lifespan of the turbine without introducing any more wear than necessary.

### BRIEF DESCRIPTION OF THE INVENTION

In an exemplary non-limiting embodiment, a system may include a gas turbine and an online wash controller configured to obtain geospatial data, and determine online wash parameters based on the geospatial data. In another exemplary non-limiting embodiment, a method is disclosed for obtaining geospatial data for an area in which a gas turbine is located and determining online wash parameters for the gas turbine based on the geospatial data. In another exemplary non-limiting embodiment, a gas turbine online wash controller may include a memory including instructions and a processor coupled to the memory that, when executing the instructions, obtains geospatial data for an area in which a gas turbine is located and determines online wash parameters for the gas turbine based on the geospatial data.

The foregoing summary, as well as the following detailed description, is better understood when read in conjunction with the drawings. For the purpose of illustrating the claimed subject matter, there is shown in the drawings examples that illustrate various embodiments; however, the invention is not limited to the specific systems and methods disclosed.

### BRIEF DESCRIPTION OF THE DRAWINGS

These and other features, aspects, and advantages of the present subject matter will become better understood when the following detailed description is read with reference to the accompanying drawings, wherein:

FIG. 1 displays an amount of precipitation for an area;

FIG. 2 displays an amount of sulfur dioxide gas for an area;

FIG. 3 displays a formation of smoke, ash, and other particles;

FIG. 4 displays the elevation of certain areas;

FIG. 5 displays an amount of dust for an area;

FIG. 6 displays an amount of accumulated rainfall in a twenty-four hour period for an area;

FIG. 7 illustrates the various layers of geospatial data which may be used in a geographic information system;

FIG. 8 illustrates the combination of the various layers of geospatial data which may be used in a geographic information system;

FIG. 9 is an exemplary illustration of a gas turbine system;

FIG. 10 illustrates a non-limiting, exemplary method of determining online wash parameters; and

FIG. 11 is an exemplary block diagram representing a general purpose computer system in which aspects of the methods and systems disclosed herein or portions thereof may be incorporated

### DETAILED DESCRIPTION OF THE INVENTION

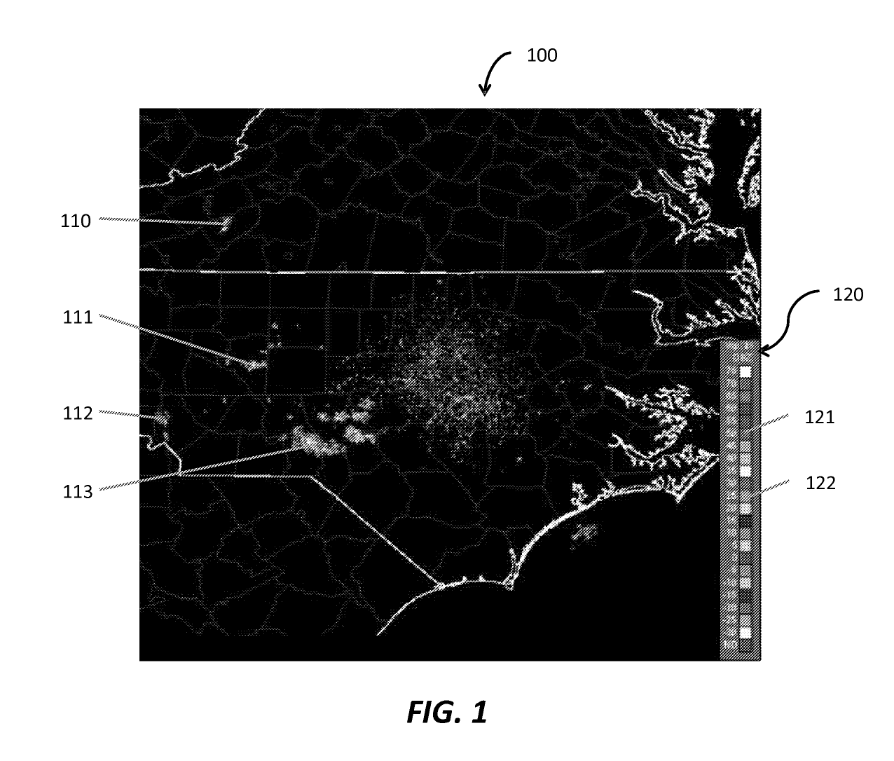

In an embodiment, geospatial atmospheric and environmental factors (referred to herein as “geospatial data”) may be used to help determine the wash frequency and duration used in a gas turbine, as well as the wash fluid blend used to wash the turbine. Geospatial data commonly takes the form of raster data or vector data. Raster data may be composed of a grid of cells, with each cell having a value. The most common type of data used in a raster cell is a color value, such as those that used in many digital image formats, though other types of data may instead be used in raster cells. The color of a raster cell in geospatial data may be cross referenced with an associated legend that provides information about the data that each color represents. FIG. 1 depicts an example of raster data 100 that represents an amount of precipitation in an area, such as area 110, area 111, area 112, and area 113 of FIG. 1. As can be seen in legend 120, the color of a particular cell may represent the “decibels relative to z” (DBZ), which corresponds to an amount of precipitation. For example, in legend 120, block 121 may be a shade of red with a corresponding DBZ value of 50 and block 122 may be a shade of green with a corresponding DBZ value of 25.

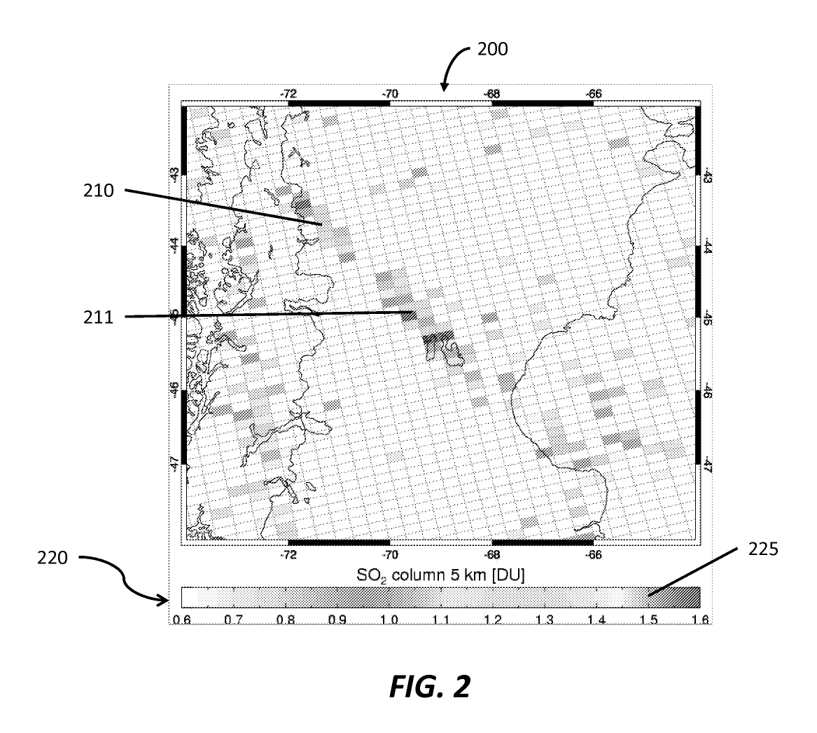

FIG. 2 shows another example of raster data 200. Raster data 200 depicts formations of SO₂ gas produced by a volcano eruption. Area 210 and area 211 are examples of raster data depicted as SO₂ gas. The color of each cell in raster data 200 may be defined by legend 220 and may represent the amount of SO₂ gas in an area. For example, at point 225 the shade may be orange and correspond to a value of 1.5 Dobson Units (DU) of SO₂ gas (i.e., the amount of SO2 gas in a five-kilometer-tall column of the atmosphere.)

In some embodiments, a raster cell value may be a raw data value that may later be depicted as a particular color, shade, pattern, or transparency in a visual display of the data. A raster cell value may also be a compound value, such as a data type which includes or incorporates both a wind speed and a wind direction component.

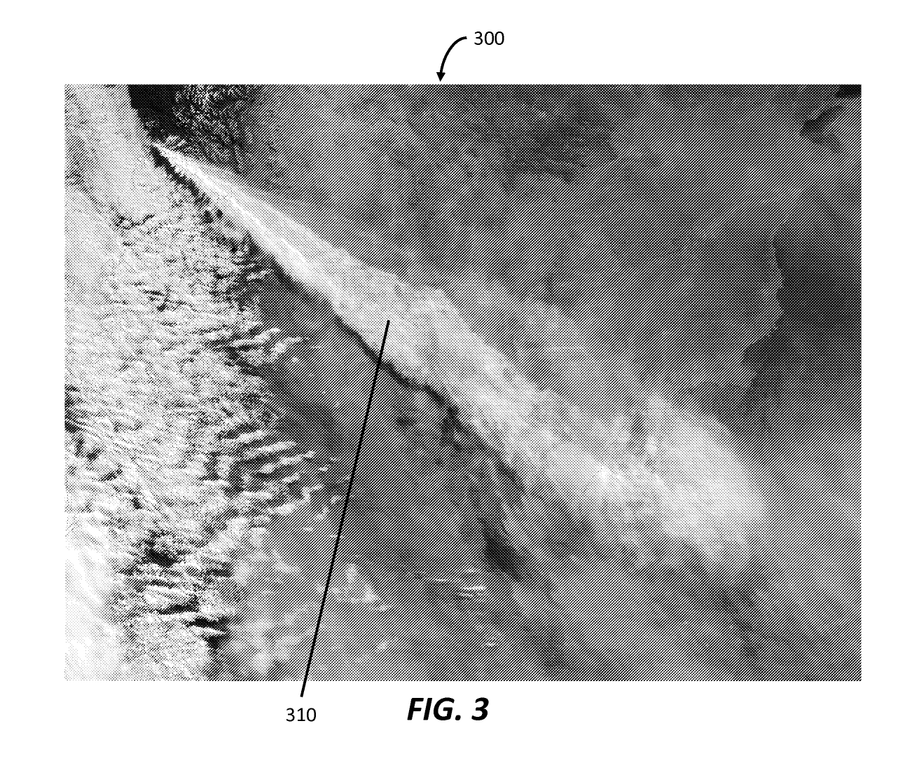

Raster data may also include raw image data, such as a photograph or drawing. FIG. 3 depicts an example of photographic raster data. FIG. 3 includes an image of an area 300 that includes a formation of smoke, ash, and other particles 310 that may have been produced by a volcanic eruption. Raw image data may also be analyzed to associate each cell in a photograph or drawing with a numerical value. For example, the image shown in FIG. 3 may be analyzed to determine a value relating to a particulate concentration for each raster cell of the image, based on the color and opacity of that raster cell.

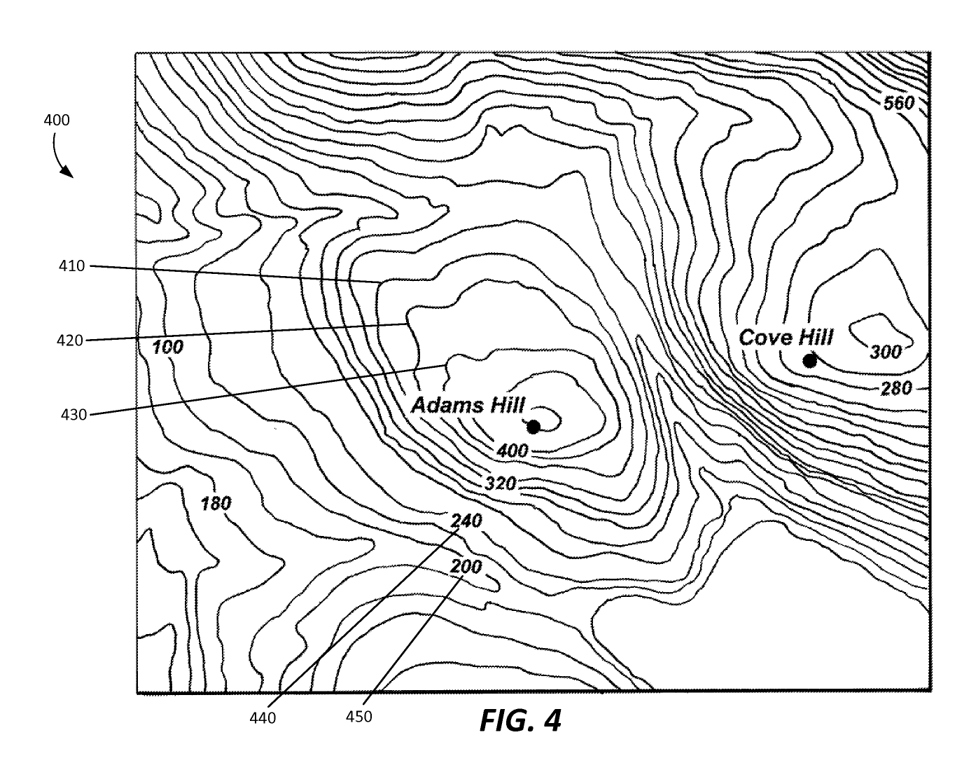

Vector data may be one or more sets of data necessary to form one or more geometrical primitives and a value or values associated with the geometrical primitive. A geometrical primitive may include a point, line, curve, shape, or polygon. For example, a set of data necessary to form a circle may include an indication that what is to be formed is a circle, the radius of the circle, and the location of the center of the circle. Each geometrical primitive may be associated with one or more values. As discussed herein, the associated value may include data relating to pollen, airborne sea salt, dust, smoke, ash, SO₂ gas, sulfate aerosols, temperature, wind, cloud formations, precipitation, precipitation type, humidity, and barometric pressure. For example, FIG. 4 depicts a vector data representation 400 that shows elevations, otherwise known as a topographical contour map. Polygon 410, polygon 420, and polygon 430 are examples of polygons that represent an area and the associated value of each polygon is the elevation of that area. The value (240) at 440 and the value (200) at 450 are each the elevation of an area associated with a polygon and are noted on the vector data representation. Another exemplary use of vector data is to represent a dust formation, where a polygon forms the outer boundary of the dust formation and the associated value includes the average amount of dust in the air.

Geospatial data may also be converted from one data type to another. For example, raster data may be converted into vector data and vice versa. Geospatial data may also be converted to other data types useful for a geographic information system. For example, photographic raster data or a plurality of photographic raster data may be converted into a single numeric value or ranking representing some aspect of the photographic raster data. To illustrate, the photographic raster data 300 shown in FIG. 3 may be analyzed as a whole and converted to a value of, for example, six on a scale of one to ten where a value of one represents no particulate matter and a value of ten represents high levels of particulate matter. In such a conversion, other sets of photographic raster data showing the same area may also be used in order to provide frames of reference. The conversion between geospatial data types may occur before the geospatial data is input into the geographic information system or as part of the geographic information system, discussed below.

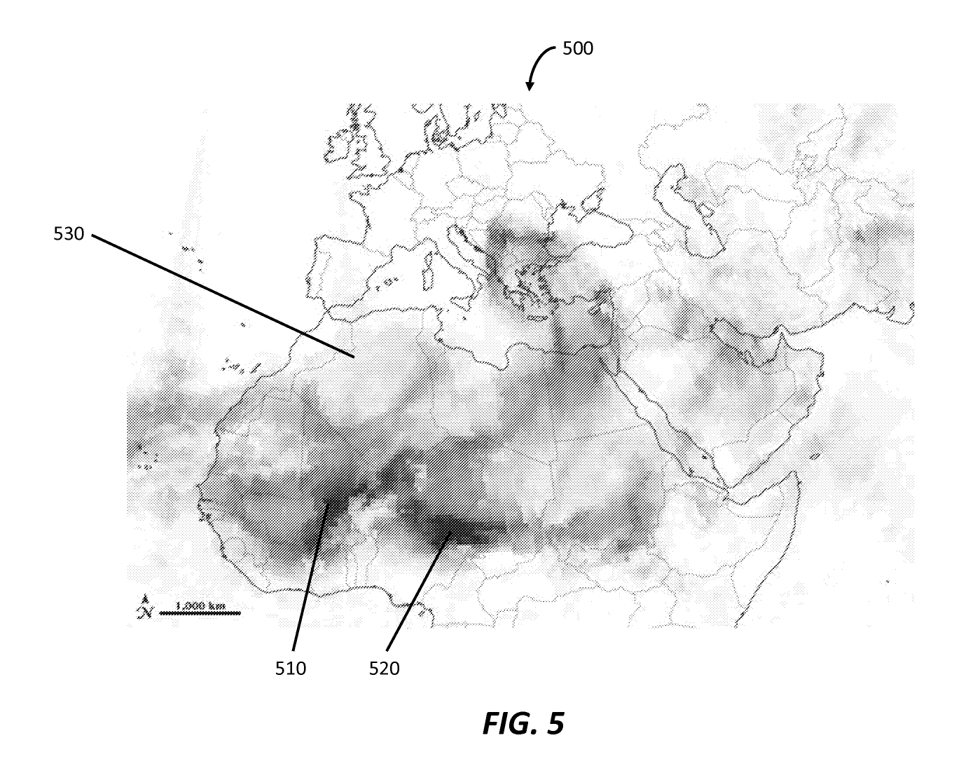

Geospatial data may be obtained from a satellite system, a radar system, and/or other sources. A satellite system may provide geospatial data by use of a photographic camera, an infrared camera, a radiation sensor, radar, lidar, and/or any other remote sensing equipment. The geospatial data provided by a satellite system may include data relating to, but not limited to, pollen, airborne sea salt, dust, smoke, ash, SO₂ gas, sulfate aerosols, and any other particulate matter. A satellite system may also provide geospatial data relating to the temperature, wind, cloud formations, and/or elevation. For example, FIG. 5 shows area 500 and geospatial data relating to dust concentrations in the air above area 500. Darker shaded areas in FIG. 5, such as section 510 and section 520, may be indicative of a higher concentration of dust, while lighter shaded areas such as section 630 may show a lower concentration of dust. FIG. 3 may illustrate another example. FIG. 3 displays a satellite photograph of an area 300 including a formation of smoke, ash, and other particles 310.

Geospatial data may be obtained using a ground-based radar system. A ground-based radar system may provide some of the same geospatial data as a satellite system, including data relating to pollen, airborne sea salt, dust, smoke, ash, and cloud formations. A ground-based radar system may also provide geospatial data relating to precipitation. FIG. 1 displays geospatial data relating to precipitation derived from a ground-based radar system.

Another exemplary source of geospatial data may be an aerial surveillance system. Similar to a satellite system, an aerial surveillance system may make use of a photographic camera, an infrared camera, a radiation sensor, radar, lidar, and/or any other remote sensing equipment mounted on an airplane or other flying vehicle.

Geospatial data is not limited to being obtained from a single source, but may include of aggregated data from a plurality of sources. For example, the geospatial data may be formed by aggregating data, such as any of the aforementioned types or other types such as precipitation type, humidity, and barometric pressure, from a network of weather stations. Furthermore, obtaining geospatial data is not limited to obtaining geospatial data directly from the aforementioned sources, but also includes indirectly obtaining geospatial data from the aforementioned sources by way of a third party such as an Internet resource, a national weather service, or an atmospheric research center.

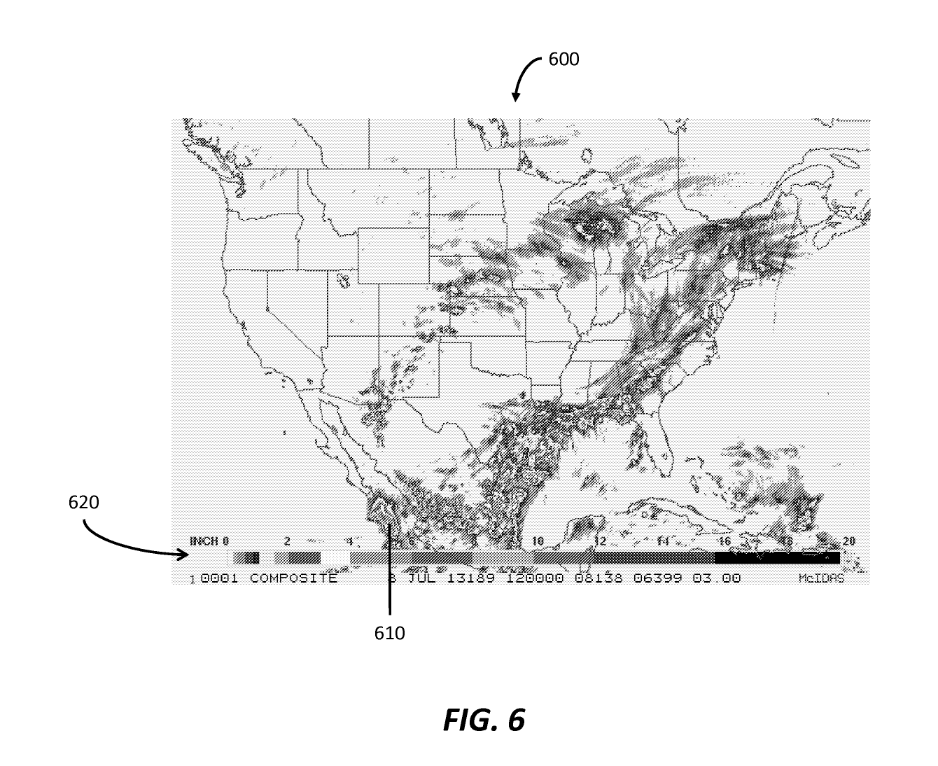

The geospatial data may be historical, projected, estimated, calculated, real-time, or a combination thereof. Historical geospatial data includes geospatial data relating to past conditions. For example, historical geospatial data may include data relating to the accumulated precipitation in an area over a past period of time. FIG. 6 shows image 600 illustrating geospatial data relating to the amount of accumulated rainfall in a twenty-four hour period. Legend 620 may be color coded to show a range of accumulation. For example, area 610 may be red in color and be indicative of significant rainfall accumulation. Historical geospatial data may also include data relating to a single past point in time (e.g., July of 2013) or series of single past points of time (e.g., each July for the past 10 years).

Projected geospatial data includes geospatial data relating to future conditions. For example, projected geospatial data may take a form similar to that illustrated in FIG. 6. But instead of being based on past rainfall accumulation, the projected geospatial data may be based on a forecasted amount of rainfall in a twenty-four hour period. Similar to historical geospatial data, projected geospatial data may be based on data relating to a single point of time, a series of single points of time, or a range of time.

Real-time geospatial data includes geospatial data relating to a present condition. Real-time geospatial data as discussed herein refers to data relating to a condition that occurred in a time span ranging from the instant of the condition occurrence to a time necessary to accommodate the time-delay introduced by automated data processing and/or network transmission. For example, an instance of real-time geospatial data may include data relating to a condition as it existed at the current time minus the processing and transmission time. Real-time geospatial data may include data relating to a condition that occurred within several seconds.

In an embodiment, location data for an area may be used in conjunction with geospatial data. Location data may include the location of a gas turbine. Location data is not limited to a single location, but may also include a plurality of locations. Location data may take a form reconcilable with the forms of other location data, such as a geographical location component of geospatial data. Location data may include a pair of latitude and longitude coordinates. Location data may also include an elevation component. Location data is not limited to a discrete location, such as a set of latitude and longitude coordinates, but may also define a location more broadly, such as the location that includes an area within a two mile radius of a particular set of latitude and longitude coordinates.

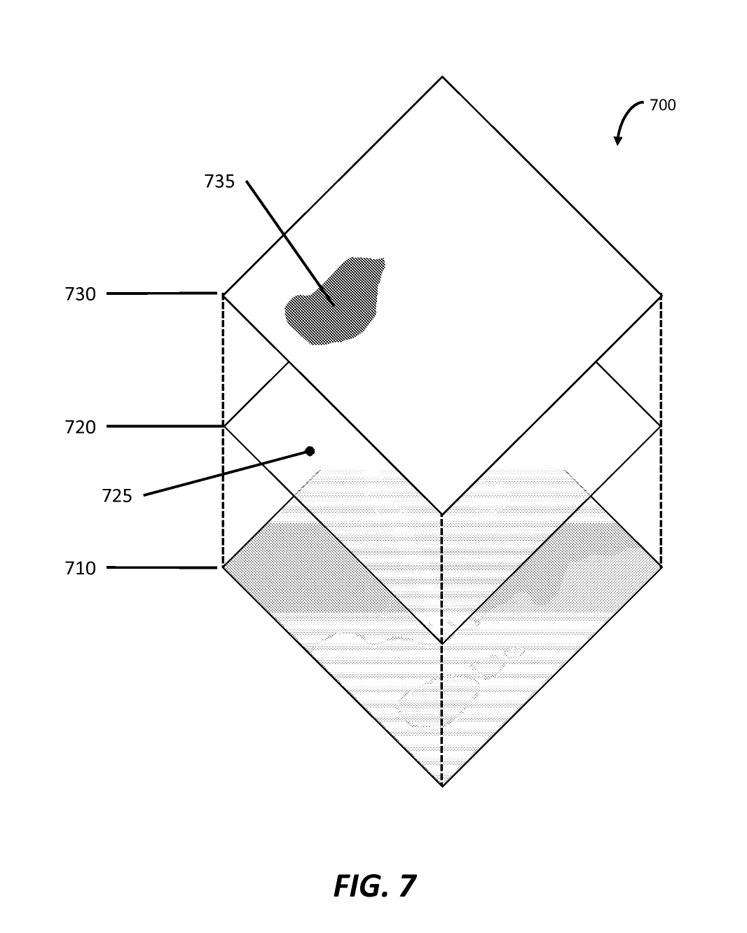

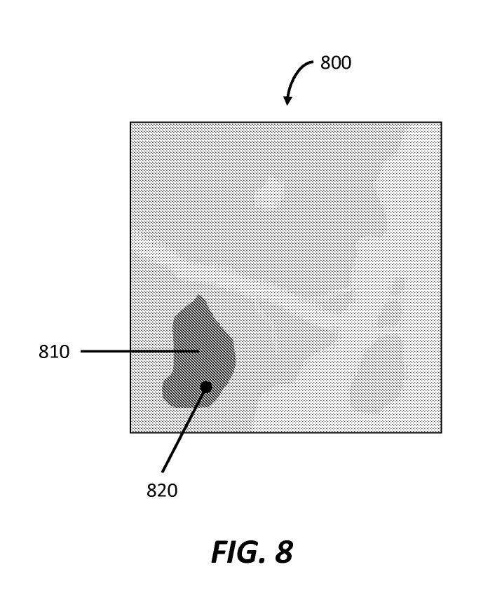

Geospatial data and location data of an area may be used by a geographic information system. A geographic information system may be a system that can store, manipulate, analyze, and present geospatial data. FIG. 7 depicts an exemplary function 700 of a geographic information system. A geographic information system may use a single or a series of geospatial data sets presented as a geographical map. Here, geospatial data representation 720 and geospatial data representation 730 may overlay the underlying geographic map 710. Underlying geographical map 710 may itself be considered a geospatial data representation. With regard to FIG. 7, the geospatial data sets include data relating to a location 725 and data relating to a dust cloud 735. As shown in FIG. 8, combined representation 800 allows the user to visually correlate the geospatial data relating to the dust cloud 810 with the location 820 on the geographic map. The overlaying geospatial data representation may be partially transparent to aid the visualization.

The geospatial data representation of FIG. 8, and any geospatial data representation generally, may take a form useful in the correlation of geospatial data with other geospatial data, including a series of points, lines, shapes, polygons, and a photographic representation. The geospatial data may be represented as a binary (e.g., either rain or no rain) as a gradient (e.g., light to heavy rain), as an absolute value (e.g., two inches of rain), or as a representative value (e.g., a two on a scale of one to ten representing relative amounts of rain). Additionally, the geospatial data may be represented as a Euclidian vector (distinct from the vector data discussed above) including a magnitude and a direction (e.g., a wind speed and a wind direction, respectively). A geographic information system may be configured to process more than one set of geospatial data so that the presented geographic map or representation may have multiple geospatial data representations overlaid simultaneously, as displayed in FIG. 8. It is also anticipated that a geographic information system may include stored geospatial data, such as the underlying geographic map 710 in FIG. 7, that may be used to analyze obtained or determined geospatial data of an area and obtained or determined location data of an area.

As disclosed herein, a geographic information system may receive, process, and store geospatial data along with location data of an area associated with a gas turbine. The geographic information system may adjust the coordinate systems of either or both of geospatial data and location data of a gas turbine so that the respective coordinate systems are consistent. A geographic information system may analyze the geospatial data and create a representation of the geospatial data. The creation of a representation of geospatial data may include converting raster data to vector data form, vector data to raster data form, and raster or vector data to relational database data or to any other form. The creation of a representation of geospatial data may also include little or no conversion, depending on the input form and the form useful to the geographic information system. The geographic information system may also combine, for example by intersection, more than one set of geospatial data to form a single geospatial representation of that data.

A geographic information system may correlate the coordinates of location data (e.g., the location of one or more gas turbines) with corresponding geospatial data for that set of coordinates, thus determining an environmental factor for the location. The geographic information system may receive more than one set of geospatial data and therefore may determine more than one environmental factor for a location. The geographic information system may also present the geospatial data representation and the location in a graphical display so that they may be visually correlated by a user.

In an embodiment, one or more operating factors relating to a gas turbine may be determined or obtained. An operating factor may be historical, projected, real-time, or any combination thereof. An operating factor may include a variety of data relating to a current operational status of a gas turbine. Examples of an operating factor include a temperature within various sections of the gas turbine, an exhaust temperature, shaft revolution speed, pressure ratio, load, power output, and compressor vane angle. An operating factor may also be a more static factor such as a model of the gas turbine, models of the parts composing the gas turbine, and properties of the materials of which the gas turbine and its parts are constructed. An operating factor may also relate to the time at load, starts, and maintenance performed on the gas turbine.

A historical operating factor may be based on one or more past events or conditions. For example, a historical operating factor may be based on the accumulated time at load or the number of starts of a gas turbine. Furthermore, a historical operating factor may be based on a set of one or more past exhaust temperature readings.

A projected operating factor is an operating factor based on one or more future events or conditions. Examples of a projected operating factor include the projected total time at load one year in the future or the projected number of maintenance services performed on the gas turbine by ten years in the future. A projected operating factor may also include a single projected piece of data, as opposed to an aggregated set, such as a projected internal temperate at a time one year in the future.

A real-time operating factor may be based on one or more events or conditions occurring at the present time. A real-time operating factor may include the current shaft revolution or the current power output of a gas turbine, for example. A real-time operating factor refers to a factor relating to an event or condition that occurred in a time span ranging from the instant of the event or condition occurrence to a time necessary to accommodate the time-delay introduced by automated data processing and/or network transmission. In other words, a real-time operating factor may include data relating to an event or condition as it existed at the current time minus the processing and transmission time. A real-time operating factor usually includes data relating to an event or condition which occurred within several seconds.

An operating factor may also be a combination of historical operation factors, projected operating factors, and real-time operating factors. For example, a running average of an exhaust temperature would include historical exhaust temperatures and a real-time exhaust temperature.

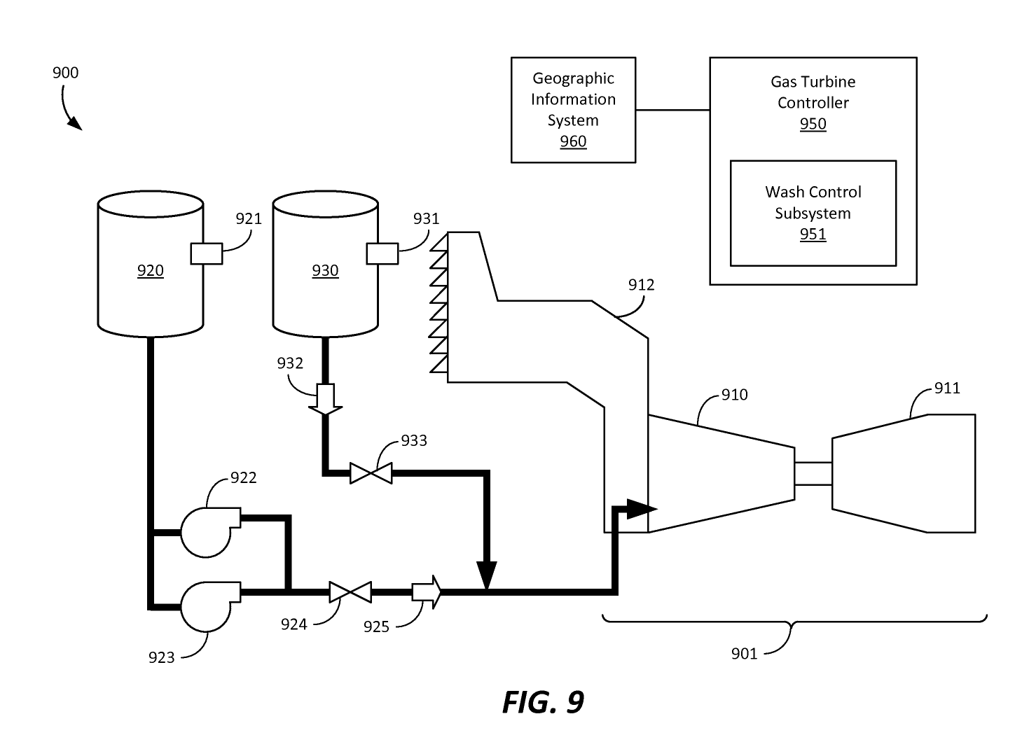

FIG. 9 illustrates exemplary non-limiting gas turbine system 900, which may include gas turbine 901, which may be configured with compressor 910, turbine 911, and air intake 912. Note that, as one skilled in the art will appreciate, gas turbine system 900 may include many other parts, components, systems, and subsystems that are not described herein in the interest of clearly describing the disclosed embodiments. Any such parts, components, systems, and subsystems may be included in embodiments disclosed herein, and all such embodiments are contemplated as within the scope of the present disclosure.

In system 900, online washing may be used to clean compressor 910 without shutting down gas turbine system 900, allowing the system to recover efficiency due to cleaner operation when an operating schedule does not permit shutdown time to perform a more thorough offline wash. Nozzles may be configured at compressor 910, in an embodiment in positions upstream or directly at the inlet to compressor 910's bellmouth casing. These nozzles may create a spray mist of water droplets, or droplets of a washing solution, within a region of relatively low velocity air. When system 900, and particularly compressor 910, is in operation, the spray mist is drawn through the bellmouth of compressor 910 and into the compressor inlet by the negative pressure produced by the rotation of compressor 910.

As will be appreciated, there are disadvantages to performing online washes too frequently or infrequently. Performing an online wash for too long or too short durations of time may also result in poorer gas turbine performance. For example, excessive online washing (e.g., performing online washing too frequently or for too long per wash cycle) may promote erosion, shortening gas turbine component lifespan. Insufficient online washing (e.g., performing online washing too infrequently or for not long enough per wash cycle) may result in increased buildup of fouling agents on the compressor blades that may also shorten gas turbine component lifespan. Inevitably, offline inspections must be performed, requiring the shutdown of gas turbine system 900 and the dismantlement of at least some of its components, which results in costly downtime. Proper online washing intervals and durations may extend the amount of time that can be permitted between offline inspections and washing. Using embodiments set forth herein, a turbine system operator may schedule online washes for times and durations that improve turbine performance and lifespan based on data relating to the environmental conditions to which gas turbine system 900 is exposed.

Storage tank 920 in FIG. 1 may contain a quantity of a blended wash fluid. Such wash fluid may be a mixture of ethanol and demineralized water, or a mixture of methanol and demineralized water, in a predetermined ratio (e.g., 50/50, but any ratio may be used in the disclosed embodiments). Other wash fluid mixtures are contemplated and may be used in the disclosed embodiments as one skilled in the art will recognize. The quantity of the blended mixture contained in storage tank 920 may be monitored by level sensor 921 and may be based on the requirements of gas turbine 901 and/or the requirements of washing processes performed thereon. The blended mixture of ethanol or methanol and demineralized water may be provided via primary supply pump 922 and backup supply pump 923 to compressor 910 for use in an online wash cycle.

In an embodiment, wash control subsystem 951, configured as part of, or in communication with, microprocessor-based gas turbine controller 950, may control one or both of pumps 922 and 923 to start, stop, and control the pumping of fluid from storage tank 920 as part of an online wash process. Note that wash control subsystems as described herein may be a system, device, component, or controller, or any combination and number thereof, that sets online wash parameters or otherwise affects online washing of a gas turbine. Wash control subsystem 951 and/or gas turbine controller 950 may be communicatively connected to, or otherwise have control over, any of the components of system 900, including components used during an online wash. Such connectivity may be provided using wired means or wireless means. Such connectivity is not shown in the figure for ease of illustrating the disclosed embodiments, but one skilled in the art will readily recognize how control of components by wash control subsystem 951 and/or gas turbine controller 950 may be implemented. Any type and combination of types of connectivity and control that may be used by wash control subsystem 951 and/or gas turbine controller 950 to control any component of system 900 may be used, and all such embodiments are contemplated as within the scope of the present disclosure.

The flow of the blended mixture to compressor 910 may be detected using flow sensor 925. To modulate this flow of wash fluid, modulating valve 924 may be controlled by wash control subsystem 951. Because wash control subsystem 951 may determine that wash fluid concentrations and contents may need to be adjusted to better address the environmental conditions to which system 900 is exposed, storage tank 930 may be included in system 900 to contain deionized water. As discussed in more detail herein, wash control subsystem 951 may determine that a more effective cleaning may be performed using a less concentrated wash fluid, and therefore may control the addition of deionized water from tank 930 by operating modulating valve 933, based on detecting a flow of deionized water using flow sensor 932. The wash fluid is ultimately delivered to the bellmouth of compressor 910, in an embodiment, through air intake 912, where it may then be used to perform an online wash cycle.

In an exemplary embodiment, wash control subsystem 951 operates under software program control to implement a set of rules for controlling the frequency, timing, and duration of online washes, and the concentration of wash fluid used in such washes. The software program may include in an exemplary embodiment a predetermined algorithm based on geospatial data as disclosed above. In an embodiment, gas turbine controller 950 and/or wash control subsystem 951 may obtain geospatial data from geographic information system 960, which may be any type and number of geographic information systems as described herein or any other type and number of systems capable of collecting and providing geospatial data. Gas turbine controller 950 and/or wash control subsystem 951 may communicate with geographic information system 960 using any means of communications. Geospatial data may be transmitted proactively by geographic information system 960 to gas turbine controller 950 and/or wash control subsystem 951 or provided upon receipt of a request for such data from gas turbine controller 950 and/or wash control subsystem 951. Such data may be provided or requested in regular intervals or continuously so as to have current geospatial data available to gas turbine controller 950 and/or wash control subsystem 951 for determining online wash frequency, duration, and fluid blend. All such embodiments are contemplated as within the scope of the present disclosure.

Gas turbine controller 950 and/or wash control subsystem 951 may also use operating factors and turbine operating parameters for determining online wash frequency, duration, and fluid blend. Operating factors may be factors such as those described above (e.g., historical operation factors, projected operating factors, and real-time operating factors). Operating parameters may include any other data or information relating to gas turbine system 900, such as operational settings that may be manually and automatically set and recalibrated. Operating factors and turbine operating parameters may be obtained at wash control subsystem 951 from gas turbine controller 950, which may obtain such data from components of system 900 using any means or methods known to those skilled in the art. Alternatively, or in addition, wash control subsystem 951 may obtain operating factors and turbine operating parameters directly from various components of system 900. All such embodiments are contemplated as within the scope of the present disclosure.

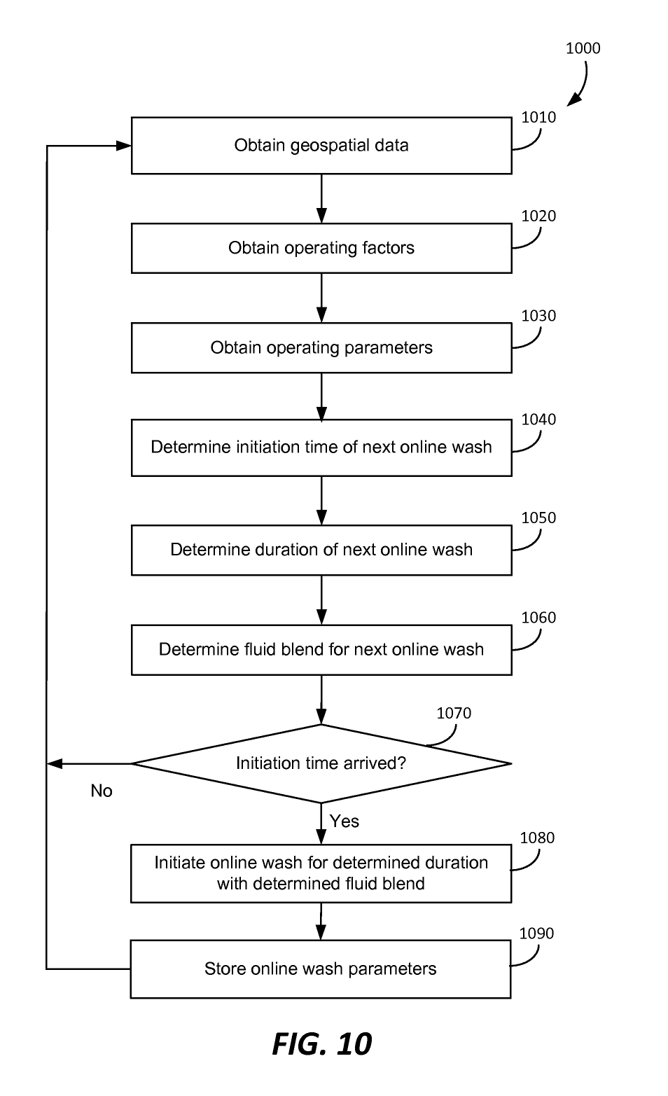

FIG. 10 illustrates method 1000 of determining and controlling online wash duration (initiation and termination of an online wash), frequency, and the fluid blend that may be used by an online wash control system or subsystem to determine parameters for an online wash. At block 1010, geospatial data may be obtained. This may be accomplished by querying a geographic information system or any other system that may provide such data or such data may be provided automatically or proactively to an online wash control system or subsystem.

At block 1020, gas turbine system operating factors may be obtained. These operating factors may include data on past online washes, including the duration of such washes, the times of wash initiation and completion, and the fluid blend used in the wash. Operating factors may be obtained by querying one or more gas turbine systems or components that may provide such data. Alternatively, such systems or components may be configured to automatically provide such data to an online wash control system or subsystem. In another alternative, such systems or components may be passive and may be monitored by one or more systems or components of a gas turbine system that in turn provide such data to an online wash control system or subsystem. In yet another embodiment, such systems or components may be passive and may be monitored by an online wash control system or subsystem. All such embodiments, and any combinations thereof, are contemplated as within the scope of the present disclosure.

At block 1030, gas turbine system operating parameters may be obtained. These parameters may include any online wash parameters that may be fixed or preconfigured, for example by a gas turbine system operator. For example, in some embodiments, the fluid blend used in online washes may not be adjustable by an online wash control system or subsystem. This may be taken into account as an operating parameter by the online wash control system or subsystem. Operating parameters may be obtained by querying one or more gas turbine systems or components that may provide such data. Alternatively, such systems or components may be configured to automatically provide such data to an online wash control system or subsystem, for example, providing automated updates when any configuration of the reporting system or component is adjusted or manipulated. In another alternative, such systems or components may be passive and may be monitored by one or more systems or components of a gas turbine system that in turn provide such data to an online wash control system or subsystem. In yet another embodiment, such systems or components may be passive and may be monitored by an online wash control system or subsystem. All such embodiments, and any combinations thereof, are contemplated as within the scope of the present disclosure.

At block 1040, a time of initiation parameter of an online wash may be determined This may be determined based on one or more of the geospatial data, operating parameters, and operating factors. Similarly, at block 1050, a duration parameter of an online wash may be determined based on one or more of the geospatial data, operating parameters, and operating factors. At block 1060, a fluid blend parameter of an online wash may be determined based on one or more of the geospatial data, operating parameters, and operating factors. The fluid blend parameter may take the form of an actual fluid blend concentration or similar value representing an actual blend of fluid, or this parameter may take the form of settings, such as modulating valve and/or fluid pump settings. All such embodiments are contemplated as within the scope of the present disclosure.

At block 1070, a determination may be made as to whether the time of initiation of the online wash has arrived. If not, method 1000 may return to block 1010 to evaluate data and determine online wash parameters again. In this way, the system executing method 1000 may continuously update the online wash parameters to respond to changing environmental and turbine conditions, thus further increasing the benefits of employing the presently disclosed embodiments. Alternatively, when the online wash initiation time has not arrived but parameters for the next online wash have been determined, the system executing method 1000 may simply await the arrival of the determined initiation time and perform the online wash when that time arrives.

If, at block 1070, it is determined that the initiation time of the next online wash has arrived, at block 1080 the online wash may be initiated and performed according to the determined online wash parameters, including using the determined fluid blend and performing the wash for the determined duration. At block 1090, the online wash parameters may be stored so that they may be accessed in future evaluations, for example when block 1020 is next executed.

Note that the online wash parameters determined according to the disclosed embodiments may be applied to individual gas turbine systems or to multiple gas turbine systems. For example, an individual gas turbine may have an online wash system controlled by a single online wash control subsystem dedicated to that turbine. Alternatively, a single online wash control system may determine online wash parameters for all gas turbines at a site, all gas turbines in a geographical region, or some other set of multiple gas turbines. All such embodiments are contemplated as within the scope of the present disclosure.

The technical effect of the systems and methods set forth herein is the reduction of wear on gas turbine parts and components by performing gas turbine online washes in a more effective manner. As will be appreciated by those skilled in the art, the use of the disclosed processes and systems may improve gas turbine operation efficiency and lifespan. Those skilled in the art will recognize that the disclosed systems and methods may be combined with other systems and technologies in order to achieve even greater gas turbine performance and efficiency. All such embodiments are contemplated as within the scope of the present disclosure.

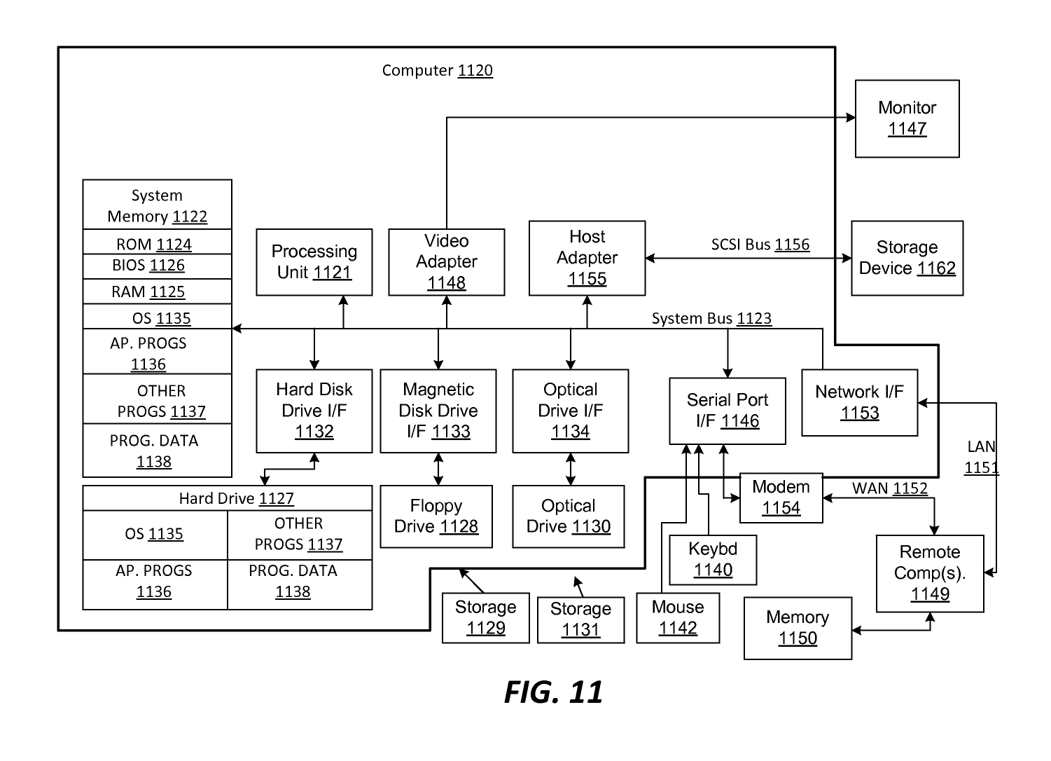

FIG. 11 and the following discussion are intended to provide a brief general description of a suitable computing environment in which the methods and systems disclosed herein and/or portions thereof may be implemented. For example, the functions of geographic information system 960, gas turbine controller 950, and wash control subsystem 951 may be performed by one or more devices that include some or all of the aspects described in regard to FIG. 11. Some or all of the devices described in FIG. 11 that may be used to perform functions of the claimed embodiments may be configured in a controller that may be embedded into a system such as those described with regard to FIG. 9. Alternatively, some or all of the devices described in FIG. 11 may be included in any device, combination of devices, or any system that performs any aspect of a disclosed embodiment.

Although not required, the methods and systems disclosed herein may be described in the general context of computer-executable instructions, such as program modules, being executed by a computer, such as a client workstation, server or personal computer. Such computer-executable instructions may be stored on any type of computer-readable storage device that is not a transient signal per se. Generally, program modules include routines, programs, objects, components, data structures and the like that perform particular tasks or implement particular abstract data types. Moreover, it should be appreciated that the methods and systems disclosed herein and/or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 11 is a block diagram representing a general purpose computer system in which aspects of the methods and systems disclosed herein and/or portions thereof may be incorporated. As shown, the exemplary general purpose computing system includes computer 1120 or the like, including processing unit 1121, system memory 1122, and system bus 1123 that couples various system components including the system memory to processing unit 1121. System bus 1123 may be any of several types of bus structures including a memory bus or memory controller, a peripheral bus, and a local bus using any of a variety of bus architectures. The system memory may include read-only memory (ROM) 1124 and random access memory (RAM) 1125. Basic input/output system 1126 (BIOS), which may contain the basic routines that help to transfer information between elements within computer 1120, such as during start-up, may be stored in ROM 1124.

Computer 1120 may further include hard disk drive 1127 for reading from and writing to a hard disk (not shown), magnetic disk drive 1128 for reading from or writing to removable magnetic disk 1129, and/or optical disk drive 1130 for reading from or writing to removable optical disk 1131 such as a CD-ROM or other optical media. Hard disk drive 1127, magnetic disk drive 1128, and optical disk drive 1130 may be connected to system bus 1123 by hard disk drive interface 1132, magnetic disk drive interface 1133, and optical drive interface 1134, respectively. The drives and their associated computer-readable media provide non-volatile storage of computer-readable instructions, data structures, program modules and other data for computer 1120.

Although the exemplary environment described herein employs a hard disk, removable magnetic disk 1129, and removable optical disk 1131, it should be appreciated that other types of computer-readable media that can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on hard disk drive 1127, magnetic disk 1129, optical disk 1131, ROM 1124, and/or RAM 1125, including an operating system 1135, one or more application programs 1136, other program modules 1137 and program data 1138. A user may enter commands and information into the computer 1120 through input devices such as a keyboard 1140 and pointing device 1142. Other input devices (not shown) may include a microphone, joystick, game pad, satellite disk, scanner, or the like. These and other input devices are often connected to the processing unit 1121 through a serial port interface 1146 that is coupled to the system bus, but may be connected by other interfaces, such as a parallel port, game port, or universal serial bus (USB). A monitor 1147 or other type of display device may also be connected to the system bus 1123 via an interface, such as a video adapter 1148. In addition to the monitor 1147, a computer may include other peripheral output devices (not shown), such as speakers and printers. The exemplary system of FIG. 11 may also include host adapter 1155, Small Computer System Interface (SCSI) bus 1156, and external storage device 1162 that may be connected to the SCSI bus 1156.

The computer 1120 may operate in a networked environment using logical and/or physical connections to one or more remote computers or devices, such as geographic information system 960, gas turbine controller 950, and wash control subsystem 951. Each of geographic information system 960, gas turbine controller 950, and wash control subsystem 951 may be any device as described herein capable of performing aspects of the disclosed embodiments. Remote computer 1149 may be a personal computer, a server, a router, a network PC, a peer device or other common network node, and may include many or all of the elements described above relative to the computer 1120, although only a memory storage device 1150 has been illustrated in FIG. 11. The logical connections depicted in FIG. 11 may include local area network (LAN) 1151 and wide area network (WAN) 1152. Such networking environments are commonplace in offices, enterprise-wide computer networks, intranets, and the Internet.

When used in a LAN networking environment, computer 1120 may be connected to LAN 1151 through network interface or adapter 1153. When used in a WAN networking environment, computer 1120 may include modem 1154 or other means for establishing communications over wide area network 1152, such as the Internet. Modem 1154, which may be internal or external, may be connected to system bus 1123 via serial port interface 1146. In a networked environment, program modules depicted relative to computer 1120, or portions thereof, may be stored in a remote memory storage device. It will be appreciated that the network connections shown are exemplary and other means of establishing a communications link between computers may be used.

Computer 1120 may include a variety of computer-readable storage media. Computer-readable storage media can be any available tangible, non-transitory, or non-propagating media that can be accessed by computer 1120 and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer-readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computer 1120. Combinations of any of the above should also be included within the scope of computer-readable media that may be used to store source code for implementing the methods and systems described herein. Any combination of the features or elements disclosed herein may be used in one or more embodiments.

This written description uses examples to disclose the subject matter contained herein, including the best mode, and also to enable any person skilled in the art to practice the invention, including making and using any devices or systems and performing any incorporated methods. The patentable scope of this disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a gas turbine; and
an online wash controller configured to:
obtain geospatial data, and
determine online wash parameters based on the geospatial data.

2. The system of claim 1, wherein the online wash controller is further configured to initiate an online wash of the gas turbine.

3. The system of claim 1, wherein the online wash controller configured to determine the online wash parameters comprises the online wash controller configured to determine an online wash initiation time.

4. The system of claim 1, wherein the online wash controller configured to determine the online wash parameters comprises the online wash controller configured to determine an online wash duration.

5. The system of claim 1, wherein the online wash controller configured to determine the online wash parameters comprises the online wash controller configured to determine an online wash fluid blend.

6. The system of claim 1, wherein the online wash controller is further configured to obtain gas turbine operating factors, and wherein the online wash controller is configured to determine the online wash parameters based on the geospatial data and the gas turbine operating factors.

7. The system of claim 1, wherein the online wash controller is further configured to obtain gas turbine operating parameters, and wherein the online wash controller is configured to determine the online wash parameters based on the geospatial data and the gas turbine operating parameters.

8. A method comprising:
obtaining geospatial data for an area in which a gas turbine is located; and
determining online wash parameters for the gas turbine based on the geospatial data.

9. The method of claim 8, further comprising initiating an online wash of the gas turbine.

10. The method of claim 8, wherein determining the online wash parameters comprises determining an online wash initiation time.

11. The method of claim 8, wherein determining the online wash parameters comprises determining an online wash duration.

12. The method of claim 8, wherein determining the online wash parameters comprises determining an online wash fluid blend.

13. The method of claim 8, further comprising obtaining gas turbine operating factors, wherein determining the online wash parameters based on the geospatial data comprises determining the online wash parameters based on the geospatial data and the gas turbine operating factors.

14. The method of claim 8, further comprising obtaining gas turbine operating parameters, wherein determining the online wash parameters based on the geospatial data comprises determining the online wash parameters based on the geospatial data and the gas turbine operating parameters.

15. A gas turbine online wash controller comprising:
a memory comprising instructions; and
a processor coupled to the memory, wherein the processor, when executing the instructions, effectuates operations comprising:
obtaining geospatial data for an area in which a gas turbine is located; and
determining online wash parameters for the gas turbine based on the geospatial data.

16. The gas turbine online wash controller of claim 15, wherein the operations further comprise initiating an online wash of the gas turbine.

17. The gas turbine online wash controller of claim 15, wherein determining the online wash parameters comprises determining an online wash initiation time.

18. The gas turbine online wash controller of claim 15, wherein determining the online wash parameters comprises determining an online wash duration.

19. The gas turbine online wash controller of claim 15, wherein determining the online wash parameters comprises determining an online wash fluid blend.

20. The gas turbine online wash controller of claim 15, wherein the operations further comprise obtaining gas turbine operating factors, and wherein determining the online wash parameters for the gas turbine based on the geospatial data comprises determining the online wash parameters for the gas turbine based on the geospatial data and the gas turbine operating factors.
